(19) United States
(12) Patent Application Publication
(10) Pub. No.: US 2017/0095881 A1
(43) Pub. Date: Apr. 6, 2017

(54) SWING ARM ASSEMBLY WITH SHIFTER FOR INTERACTING WITH A SPOT WELDING TIP

(71) Applicant: G.E. Schmidt, Inc., Blue Ash, OH (US)

(72) Inventors: Drew Sherlock Johnson, Montgomery, OH (US); Andrew Ryan Johnson, Cincinnati, OH (US); Jonathan Michael Dutton, Cincinnati, OH (US); Steven Mathew Daviaux, Somerville, OH (US); Dilshan Thilina Modaragamage, Barrie (CA)

(21) Appl. No.: 15/286,013

(22) Filed: Oct. 5, 2016

Related U.S. Application Data
(60) Provisional application No. 62/353,912, filed on Jun. 23, 2016.
(60) Provisional application No. 62/237,791, filed on Oct. 6, 2015.

(51) Int. Cl. B23K 11/30; B23K 11/11

(52) U.S. Cl. CPC B23K 11/3063; B23K 11/11; B23K 11/3072

(57) ABSTRACT

A swing arm assembly is provided for a spot welding machine. The swing arm assembly can accommodate a tip dresser or a tip exchanger and can include a shifter that can translate the tip dresser from a first position to a second position along a lateral axis.

### REFERENCE TO RELATED APPLICATIONS

This application claims priority to U.S. Provisional Patent Application Ser. Nos. 62/237,791, filed Oct. 6, 2015 and 62/353,912, filed Jun. 23, 2016, the contents of each of which are incorporated herein by reference.

### BACKGROUND

In spot welding, the electrode tips (weld tips) can get worn and dirty and are thus cleaned periodically to maintain good quality welds. When the weld gun is carried by a robot, the robot can bring the gun to the tip dresser for cleaning. However, some weld guns are fix mounted and thus utilize a swing arm that brings the tip dresser to the electrode tips for cleaning.

### SUMMARY

In accordance with one embodiment, a swing arm for one or more of a tip dresser and a tip exchanger for a spot welding machine is provided. The swing arm comprises a base, an arm, and a shifter. The arm is pivotally coupled with the base. The shifter is coupled with the arm and comprises a body and a slide plate. The slide plate is configured to accommodate one or more of a tip dresser and a tip exchanger for a spot welding machine. The slide plate is movable with respect to the body along a first axis between a first position and a second position.

In accordance with another embodiment, a welding system comprises a spot welding machine, a swing arm, and one or more of a tip dresser and a tip exchanger. The swing arm comprises a base, an arm, and a shifter. The arm is pivotally coupled with the base. The shifter is coupled with the arm and comprises a body and a slide plate. The slide plate is movable with respect to the body along a first axis between a first position and a second position. The one or more of a tip dresser and a tip exchanger is coupled with the slide plate.

In accordance with another embodiment, a shifter for a swing arm for one or more of a tip dresser and a tip exchanger for a spot welding machine is provided. The shifter comprises a body and a slide plate. The slide plate is configured to accommodate one or more of a tip dresser and a tip exchanger for a spot welding machine. The slide plate is movable with respect to the body along a first axis between a first position and a second position.

### BRIEF DESCRIPTION OF THE DRAWINGS

Various embodiments will become better understood with regard to the following description, appended claims and accompanying drawings wherein:

FIG. 1 is a perspective view of a swing arm assembly according to one embodiment, having a tip dresser coupled to the swing arm assembly;

FIGS. 2-5 are various views depicting a head of the swing arm assembly;

FIG. 6 is a perspective view depicting a swing arm assembly according to another embodiment;

FIG. 7 is a perspective view depicting a swing arm assembly according to yet another embodiment;

FIG. 8 is a perspective view depicting a swing arm assembly according to yet another embodiment;

FIG. 9 is a perspective view depicting a swing arm assembly according to yet another embodiment;

FIG. 10 is a perspective view depicting an alternative embodiment of a head of a swing arm;

FIG. 11 is a perspective view depicting another alternative embodiment of a head of a swing arm;

FIG. 12 is a perspective view depicting yet another alternative embodiment of a head of a swing arm;

FIGS. 13-15 are various views depicting yet another alternative embodiment of a swing arm assembly;

FIGS. 16-19 are various views depicting yet another alternative embodiment of a swing arm assembly; and

FIGS. 20-25 are various views depicting a swing arm assembly having a shifter according to one embodiment.

### DETAILED DESCRIPTION

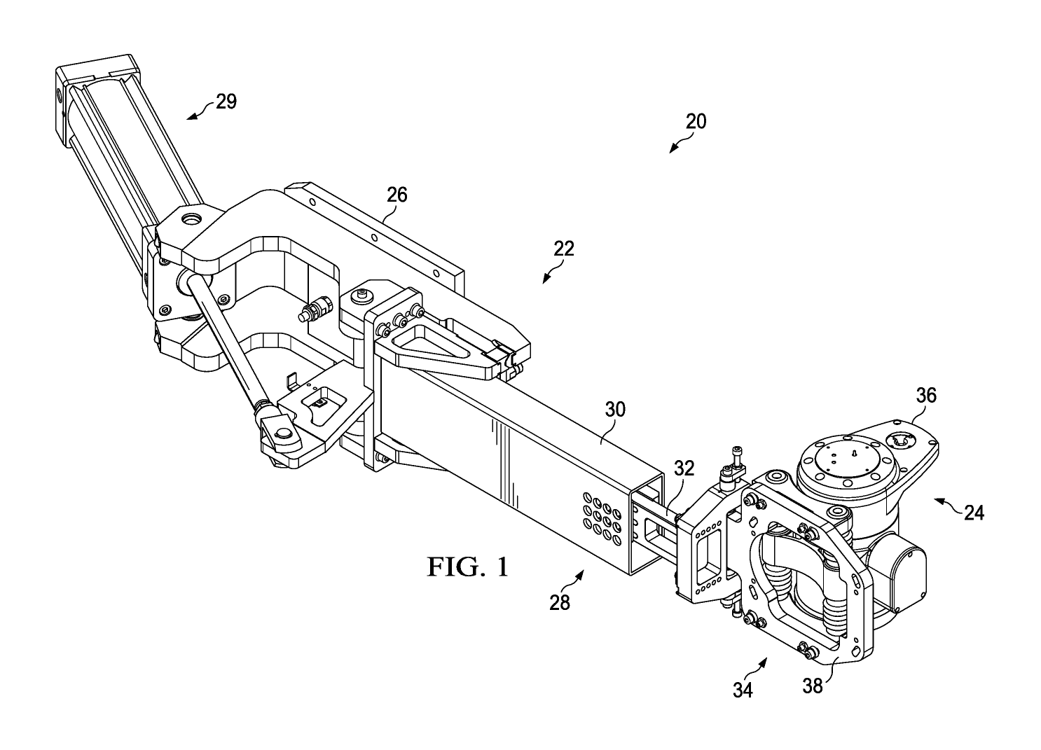

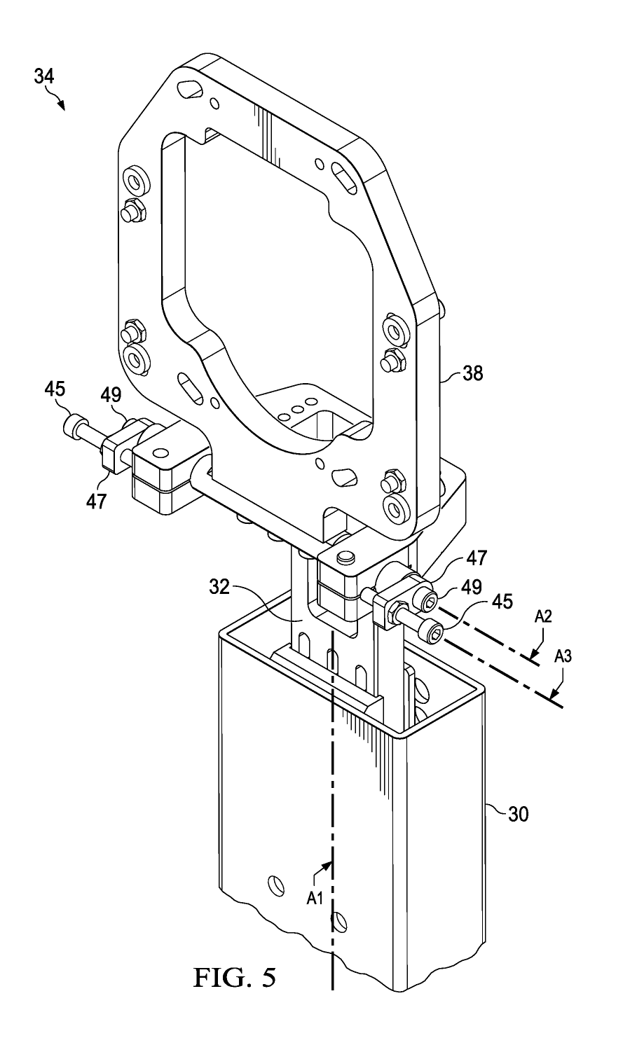

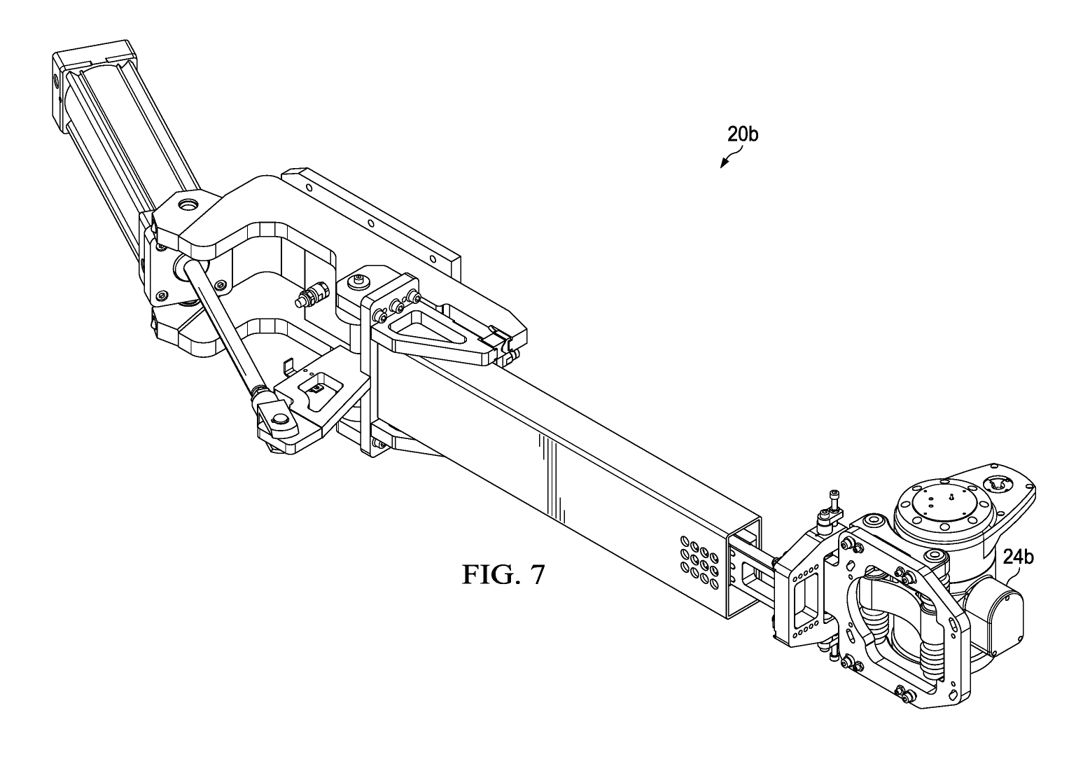

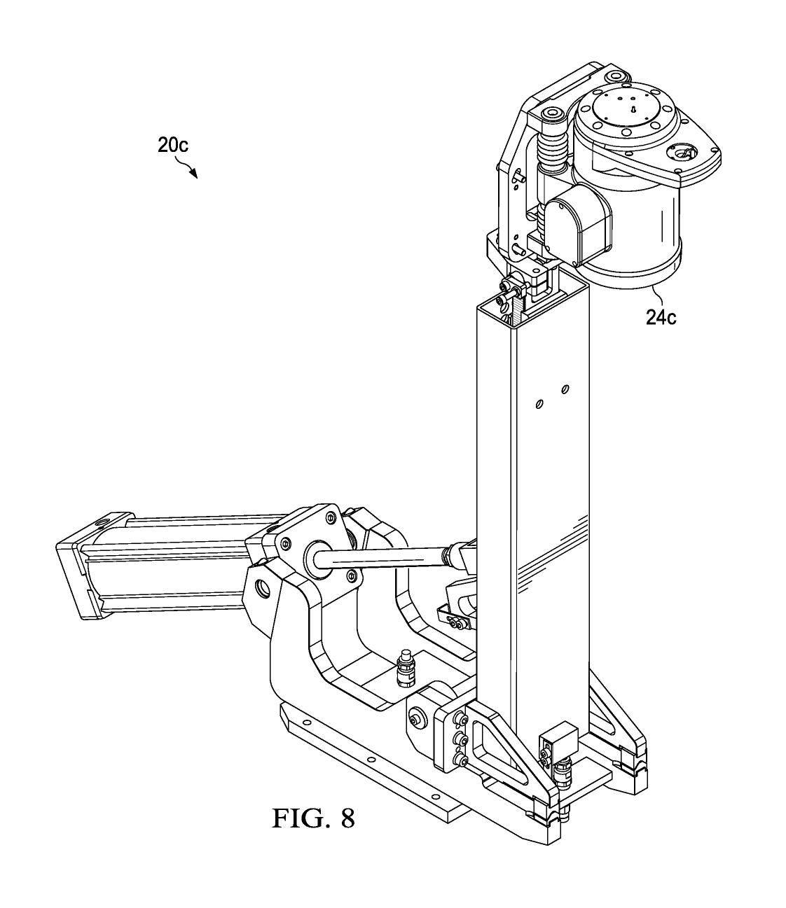

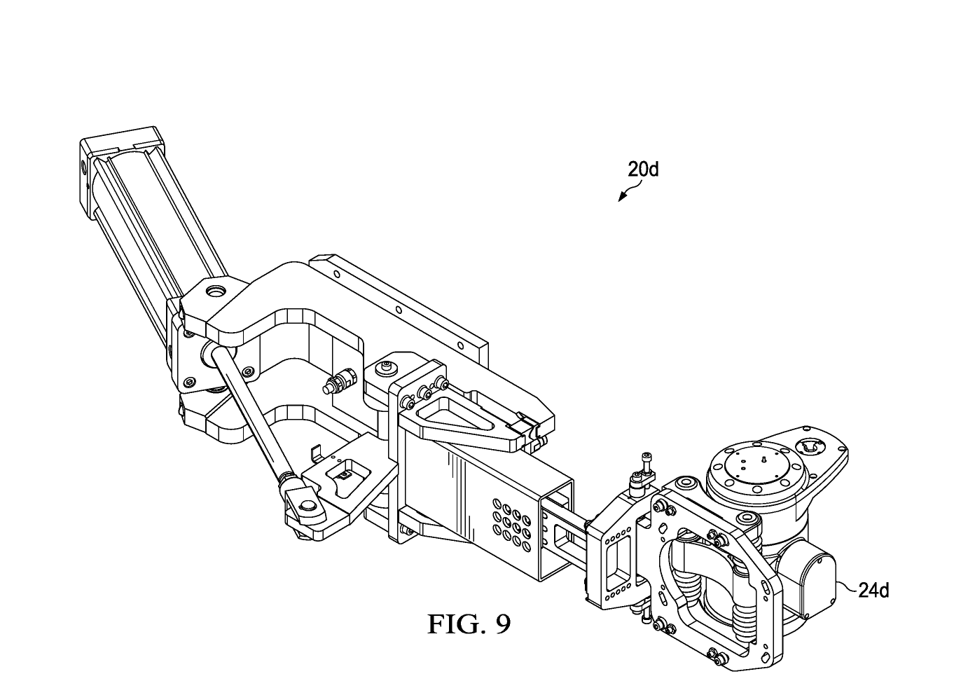

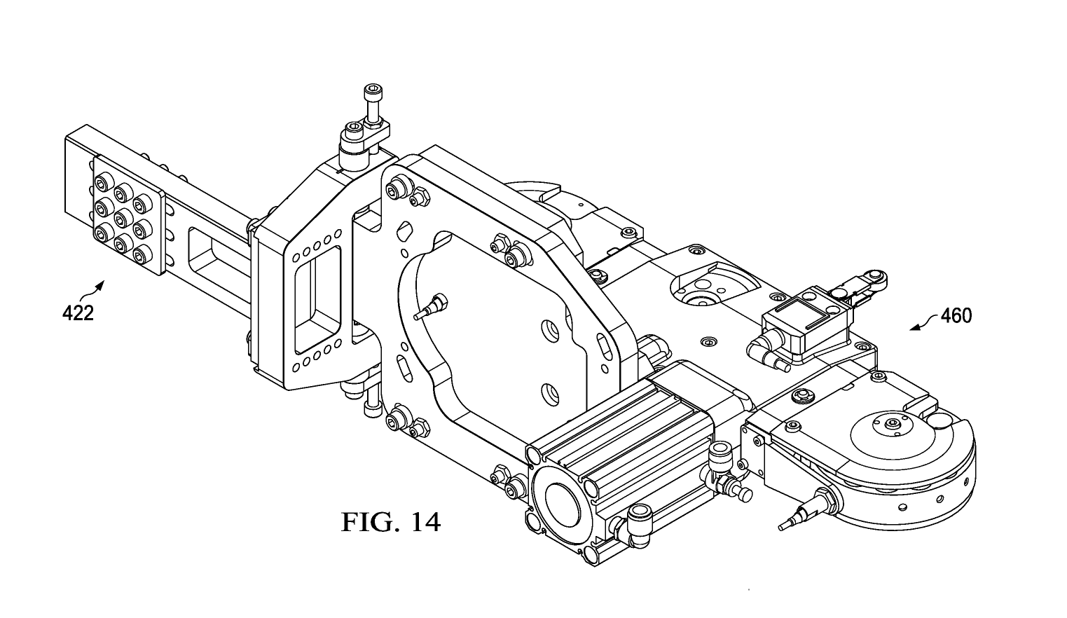

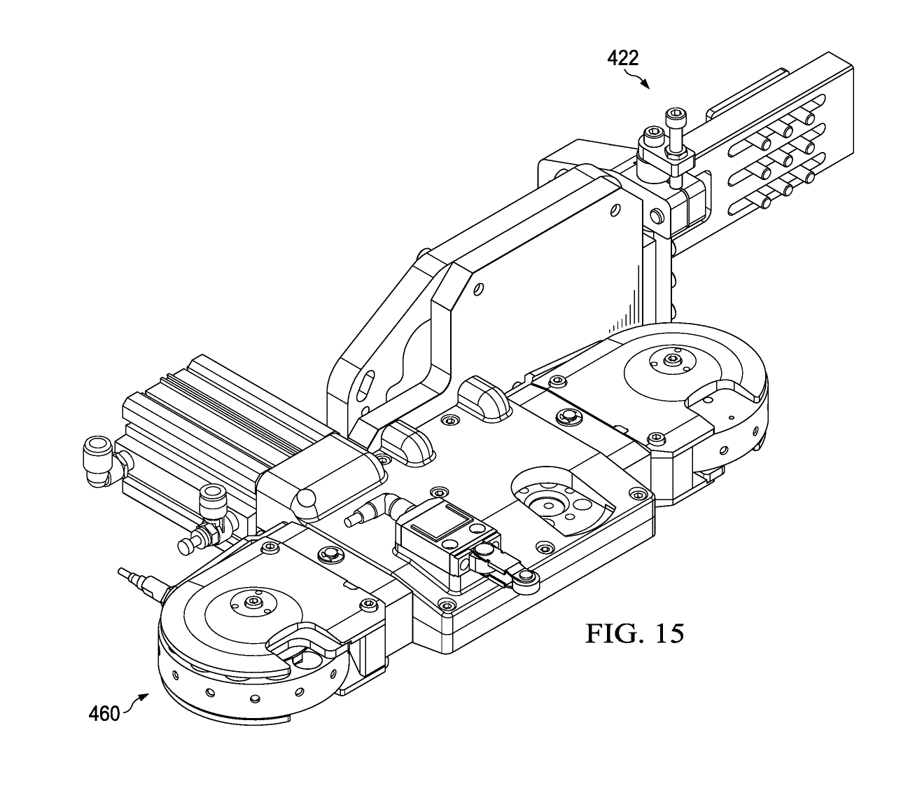

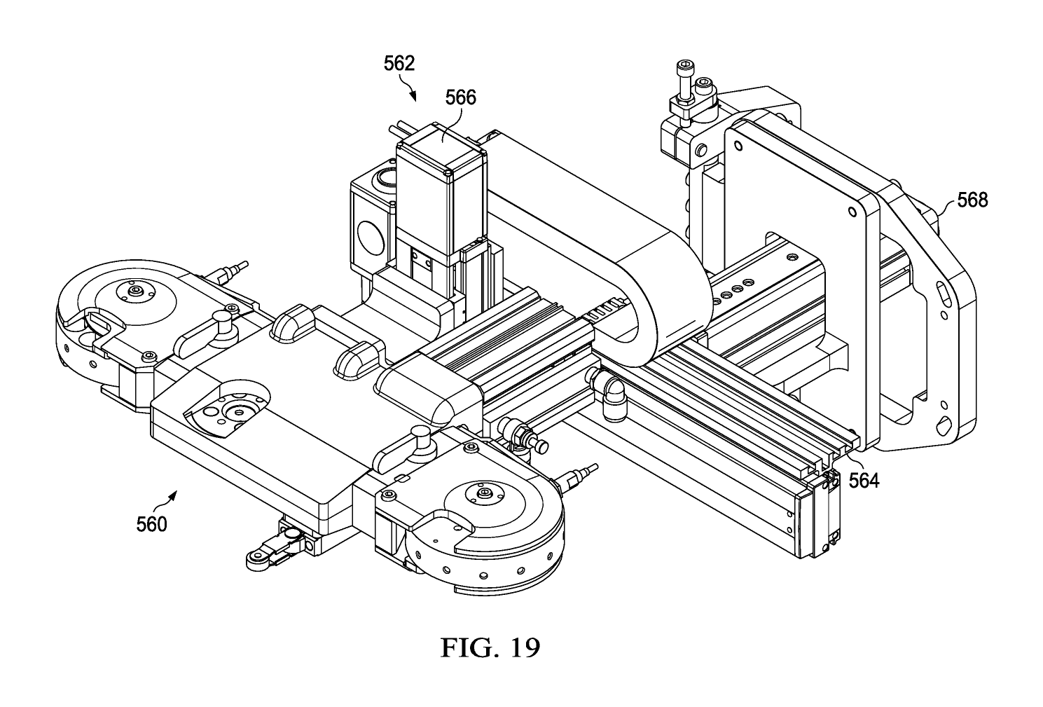

Embodiments are hereinafter described in detail in connection with the views and examples of FIGS. 1-25, wherein like numbers indicate the same or corresponding elements throughout the views. As illustrated in FIG. 1, a swing arm assembly 20 is provided that can include a swing arm 22 and a tip dresser 24. The swing arm 22 can selectively position the tip dresser 24 with respect to welding tips of a spot welder (not shown) to facilitate cleaning/dressing of the welding tips. The swing arm 22 can include a mounting base 26, an arm assembly 28 pivotally coupled to the mounting base 26, and a driver cylinder 29 pivotally coupled to the mounting base 26. The driver cylinder 29 can operably mounted to the arm assembly 28 to facilitate in pivoting of the arm assembly 28 with respect to the mounting base 26. In one embodiment, the driver cylinder 29 can be a pneumatic drive. In other embodiments, any of a variety of drives can be used to facilitate powered pivoting of the arm assembly 28, such as, for example, a servo. The arm assembly 28 can include an arm 30, an extendible arm mount 32, and a head 34. The extendible arm mount 32 can be slidably coupled with the arm 30 and slidable between a retracted position and an extended position. The head 34 can be mounted to the extendable arm mount 32 and can be configured to accommodate the tip dresser 24.

The mounting base 26 can facilitate mounting of the swing arm assembly 20 to with fasteners (e.g., with bolts), to a floor, or at any of a variety of other suitable locations that allow the tip dresser 24 to interact properly with the spot welding machine (not shown). For example, when the spot welding machine is operating, the swing arm 22 can be in a stand-by position, such that the tip dresser 24 remains out of the operational zone of the spot welding machine. Once the welding tips are ready for dressing, the spot welding machine can cease spot welding, and the swing arm 22 can pivot the tip dresser 24 into position (via operation of the driver cylinder 29 and/or sliding of the extendible arm mount 32). The spot welding machine can then bring the welding tips into contact with a cleaning mechanism 36 on the tip dresser 24 to facilitate dressing of the welding tips. In one embodiment, the swing arm 22 can move the tip dresser 24 into place without requiring substantial movement of the spot welder. In another embodiment, the swing arm 22 and the spot welding machine can move together such that they meet at a predetermined location.

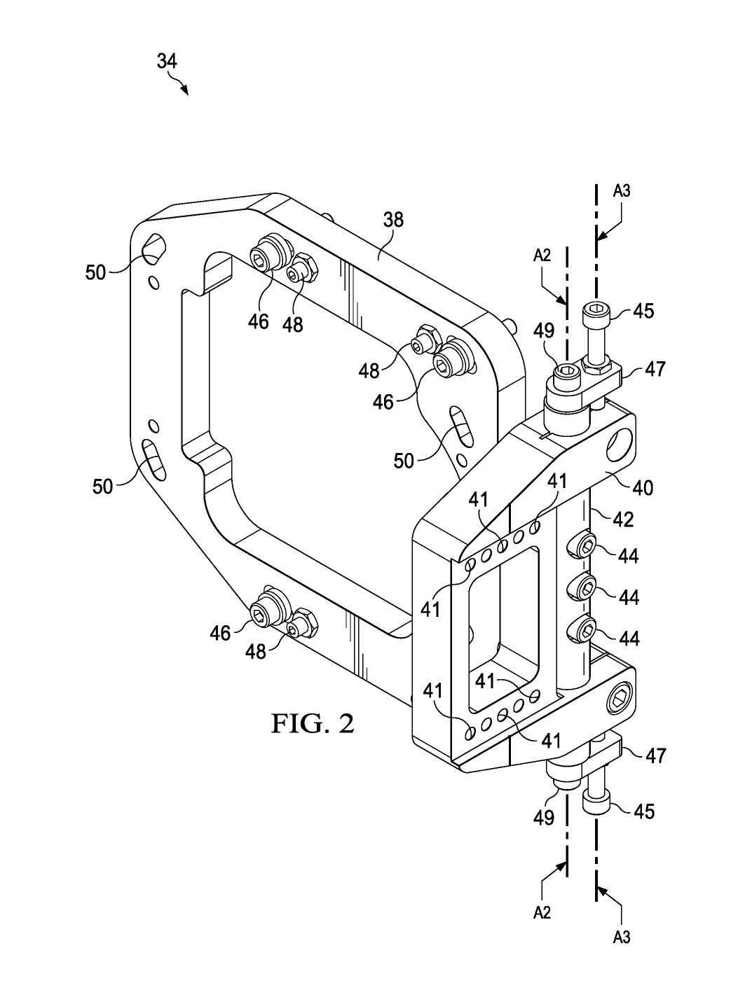

Referring now to FIGS. 2-5, the head 34 can include a mount plate 38 that is rotatably coupled with a support member 40 by a rotational adjustment tube 42 such that the mount plate 38 is rotatably about an axis A2. The support member 40 can include a plurality of mount holes 41 that allow for mounting of the support member 40 to the arm mount 32 in different positions. For example, the position of the support member 40 can be laterally adjusted by selecting different mount holes 41 by which to attach the support member 40 to the arm mount 32. The mount plate 38 can be releasably coupled to the rotational adjustment tube 42 by a plurality of fasteners 44. A pair of vertical adjustment bolts 45 can be associated with the support member 40 and can facilitate vertical positioning of the mount plate 38 with respect to the support member 40. Each of the vertical adjustment bolts 45 can be threaded through an extension plate 47 and into contact with the support member 40 on opposite sides of the support member 40. The vertical adjustment bolts 45 can be rotated in opposite directions (e.g., about an axis A3) to facilitate sliding of the rotational adjustment tube 42 along the axis A2. For example, one of the vertical adjustment bolts 45 can be rotated clockwise (e.g., to thread the vertical adjustment bolt 45 towards the support member) and the other vertical adjustment bolt 45 can be rotated counterclockwise (e.g., to thread the vertical adjustment bolt 45 away from the support member) to facilitate sliding of the rotational adjustment tube 42 along the axis A2.

The rotational adjustment tube 42 and the extension plates 47 can be releasably secured together by respective bolts 49 such that the rotational adjustment tube 42 is disposed between the extension plates 47. The bolts 49 can facilitate releasable securement of the rotational adjustment tube 42 in place. For example, the bolts 49 can be loosened to allow the rotational adjustment tube 42 to be pivoted about the axis A2. Once the rotational adjustment tube 42 is pivoted into a desired position, the bolts 49 can be tightened to hold the rotational adjustment tube 42 in place. In one embodiment, as illustrated in FIG. 2, the vertical adjustment bolts 45 can be offset from the axis A2 and arranged such that the axes A2 and A3 are substantially parallel but not coaxial (e.g., each vertical adjustment bolt 45 is spaced from the adjacent bolt 49).

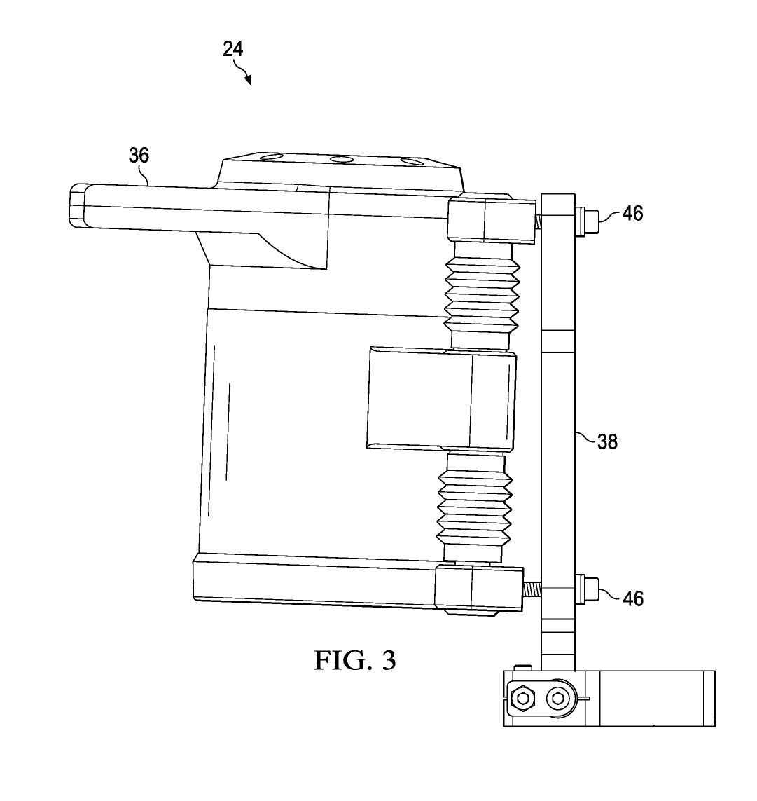

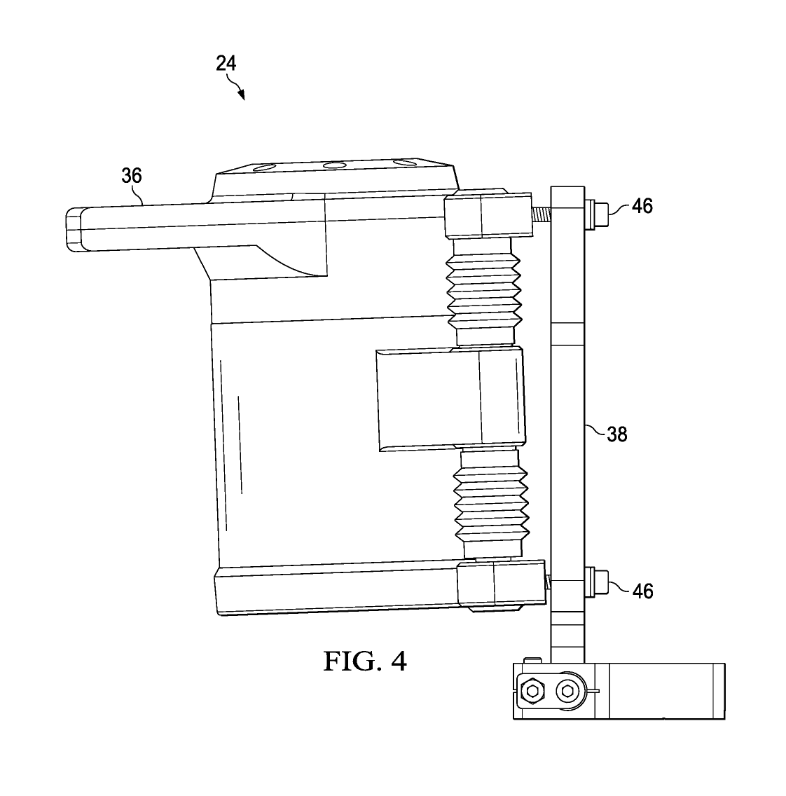

Still referring to FIG. 2, the mount plate 38 can include a plurality of adjustment screws (e.g., 46) and adjustment jacking bolts (e.g., 48). As illustrated in FIGS. 3 and 4, the tip dresser 24 can be releasably attached to the mount plate 38 by the adjustment screws (e.g., 46). The adjustment screws (e.g., 46) and adjustment jacking bolts (e.g., 48) can cooperate to permit fine tuning of the positioning of the tip dresser 24 upon the mount plate 38. For example, as illustrated in FIGS. 3 and 4, the spacing of each side of the tip dresser 24 can be adjusted with the adjustment screws (e.g., 46). Referring again to FIG. 2, the adjustment screws (e.g., 46) can be provided through slotted holes 50 in the mount plate 38 that allow for fine tuning of the rotational position of the tip dresser 24 during installation. It is to be appreciated that when the tip dresser 24 is attached to the head 34, the positioning of the tip dresser 24 can be adjusted to ensure proper interaction with the welding tips of the spot welder (e.g., by adjusting any of the plurality of fasteners 44, the pair of vertical adjustment bolts 45, the adjustment screws (e.g., 46) and the adjustment jacking bolts (e.g., 48)).

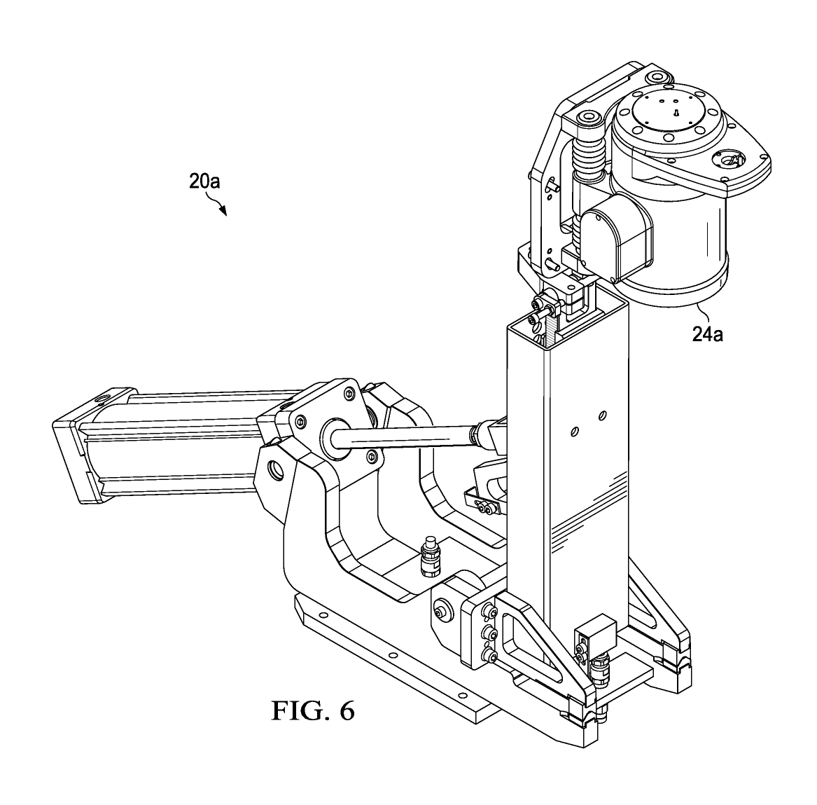

FIGS. 6-9 illustrate various alternative embodiments of swing arm assemblies (20a, 20b, 20c, and 20d, respectively) that are similar to the swing arm assembly 20 illustrated in FIGS. 1-5 except that the swing arm assemblies (20a, 20b, 20c, and 20d, respectively) have different arm lengths and the tip dressers (24a, 24b, 24c, and 24d, respectively) are provided in different orientations.

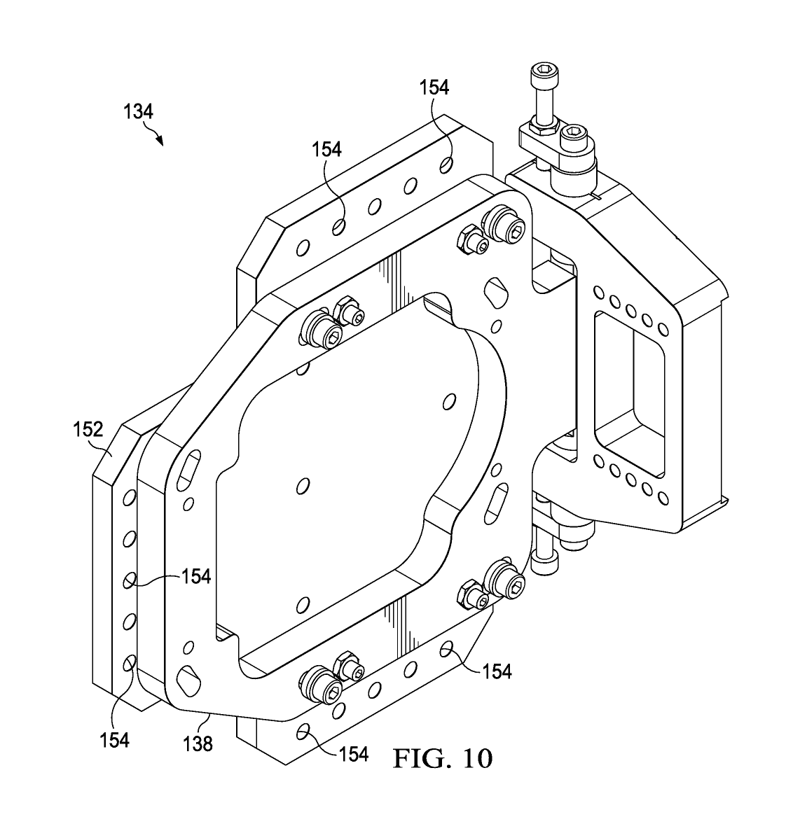

FIG. 10 illustrates an alternative embodiment of a head 134 for a swing arm assembly, the head 134 being similar to, or the same as in many respects as, the head 34 illustrated in FIGS. 1-5. However, the head 134 can include an adapter plate 152 releasably secured to a mount plate 138. The adapter plate 152 can include a plurality of holes 154 that can accommodate a variety of different tip dressers (not shown).

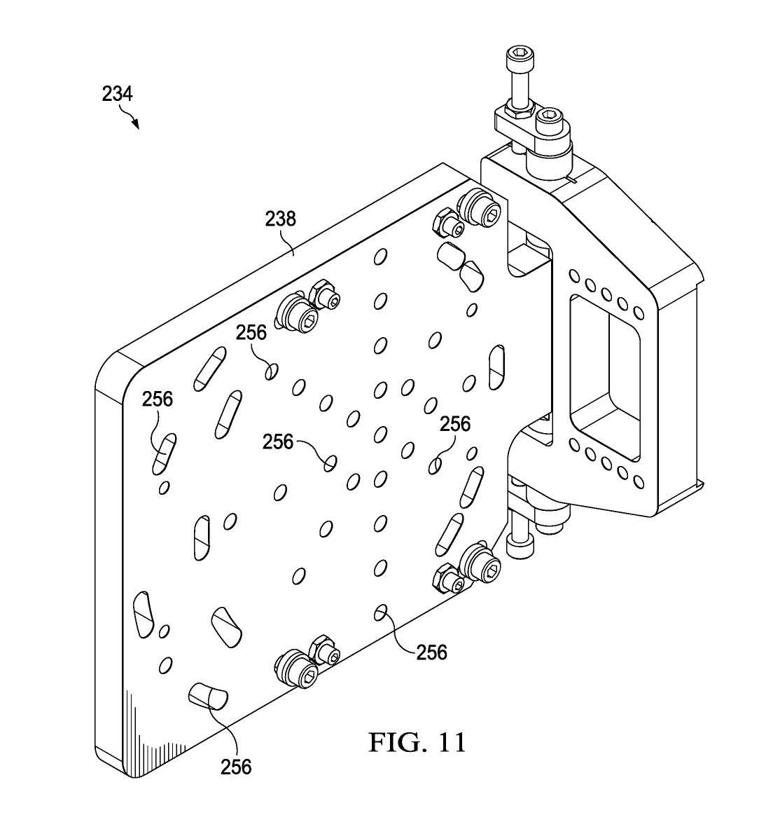

FIG. 11 illustrates another alternative embodiment of a head 234 for a swing arm assembly, the head 234 being similar to, or the same as in many respects as, the head 34 illustrated in FIGS. 1-5. However, a mount plate 238 of the head 234 can include a plurality of different holes 256 that are distributed along the mount plate to accommodate a variety of different tip dressers (not shown).

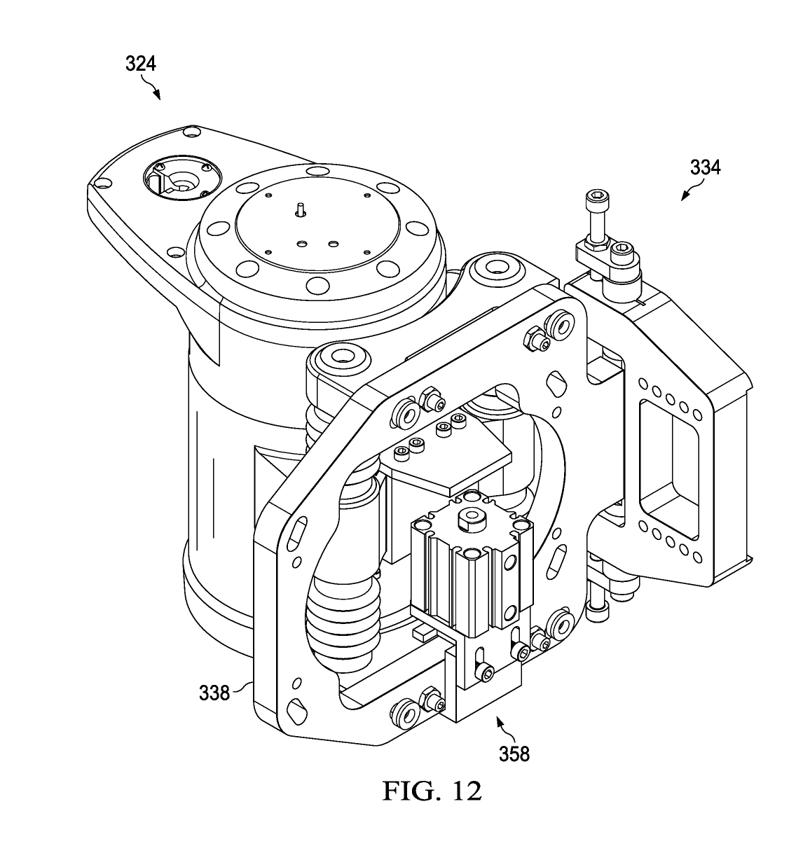

FIG. 12 illustrates another alternative embodiment of a head 334 for a swing arm assembly, the head 334 being similar to, or the same as in many respects as, the head 34 illustrated in FIGS. 1-5. For example, a tip dresser 324 can be mounted to a mount plate 338 of the head 334. However, a lift kit 358 can be releasably secured to the mount plate 338 and can be operably coupled with the tip dresser 324. The lift kit 358 can be configured to facilitate powered vertical movement of the tip dresser 324 for effective positioning of the tip dresser 324 with respect to welding tips.

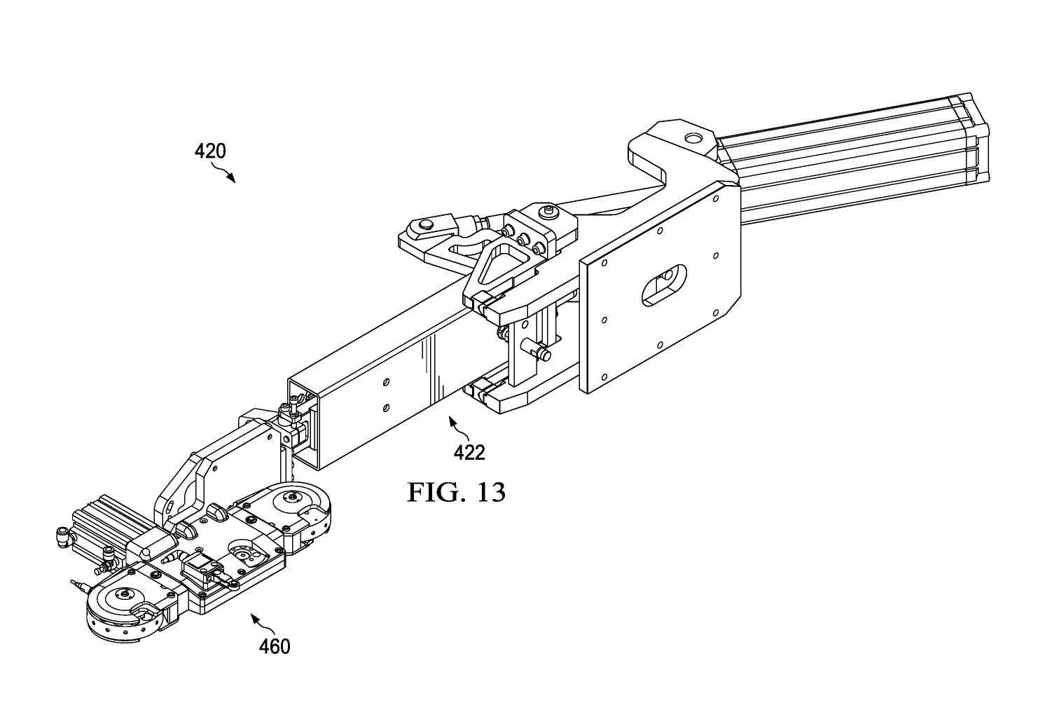

FIGS. 13-15 illustrate yet another alternative embodiment of a swing arm assembly 420 that is similar to, or the same as in many respects as, the swing arm assembly 20 illustrated in FIGS. 1-5. For example, the swing arm assembly 420 can include a swing arm 422. However, the swing arm assembly 420 can include a tip exchanger 460 that is configured to facilitate replacement of tips of a spot welding machine.

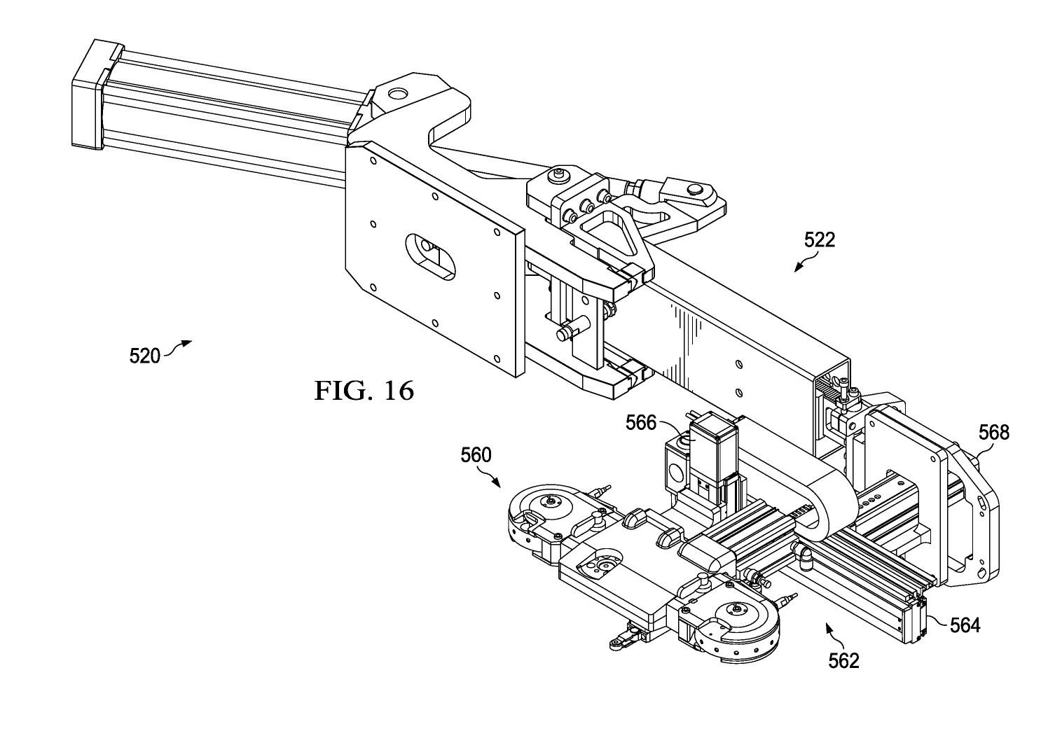

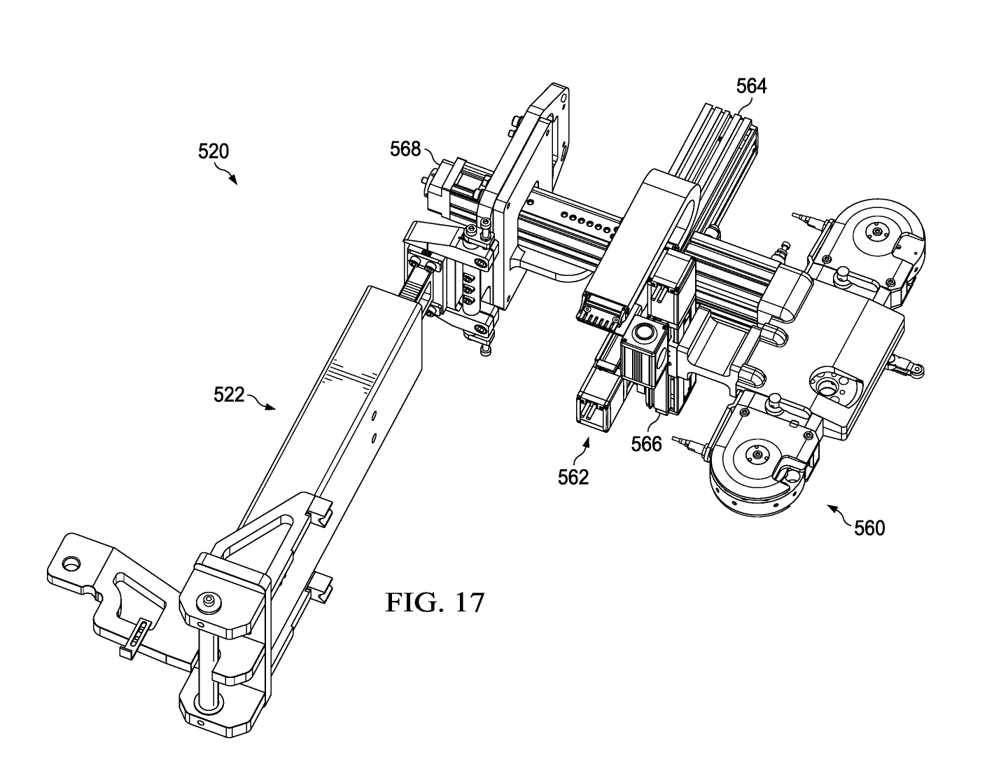

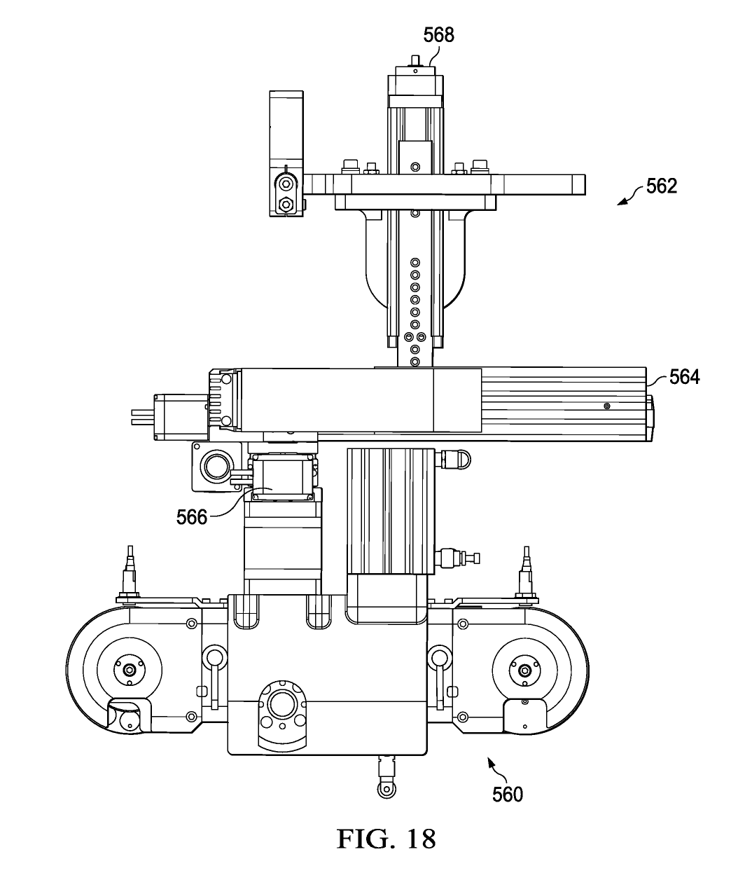

FIGS. 16-19 illustrate yet another alternative embodiment of a swing arm assembly 520 that is similar to, or the same as in many respects as, the swing arm assembly 20 illustrated in FIGS. 1-5. For example, as illustrated in FIGS. 16 and 17, the swing arm assembly 520 can include a swing arm 522. However, the swing arm assembly 520 can include a tip exchanger 560 that is configured to facilitate replacement of tips of a spot welding machine. The swing arm assembly 520 can also include an XYZ servo positioning system 562 (FIG. 18) that includes an X-axis servo slide 564, a Y-axis servo slide 566, and a Z-axis servo slide 568 that cooperate to facilitate three-dimensional positioning of the tip exchanger 560 with respect to a spot welding machine (not shown).

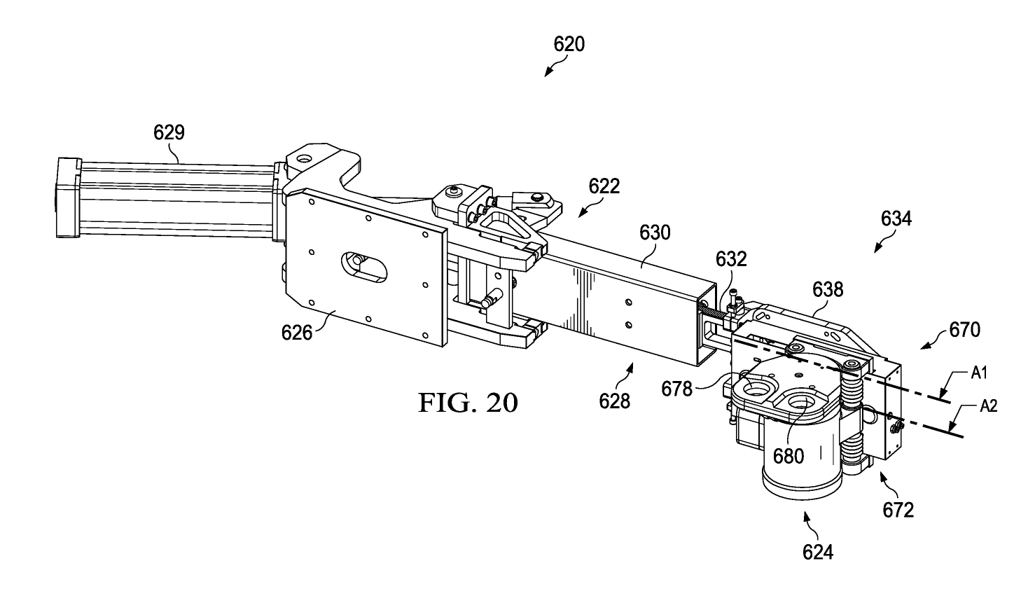

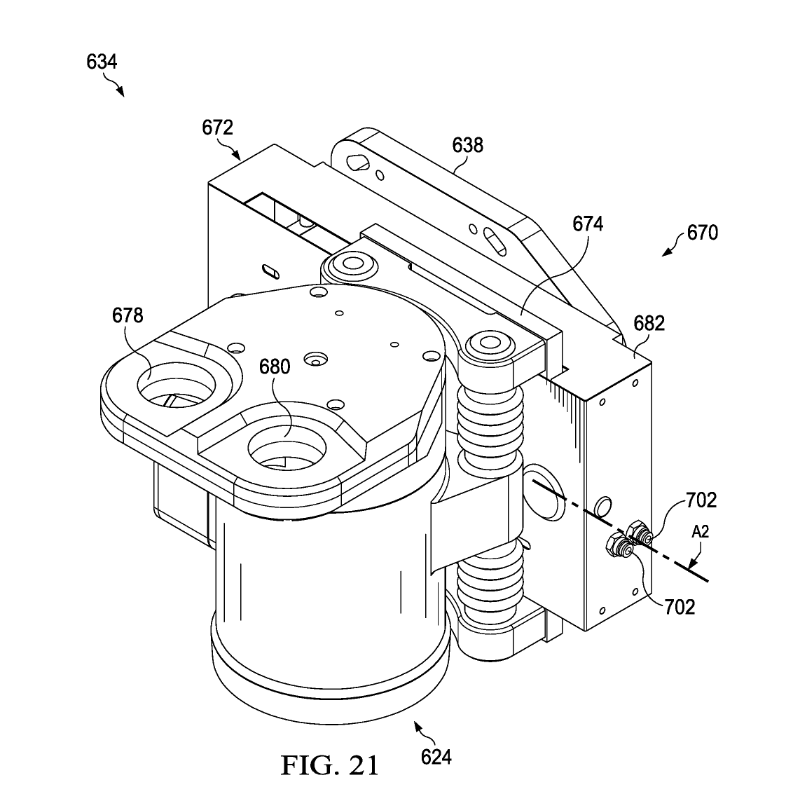

Embodiments of a swing arm system having a slider or shifter are hereinafter described in detail in connection with the views and examples of FIGS. 20-25. As illustrated in FIGS. 20 and 21, a swing arm assembly 620 is provided that can include a swing arm 622 and a tip dresser 624. The swing arm 622 can selectively position the tip dresser 624 with respect to welding tips of a spot welder (not shown) to facilitate cleaning/dressing of the welding tips. The swing arm 622 can include a mounting base 626, an arm assembly 628 coupled to the mounting base 626, and a driver cylinder 629 pivotally coupled to the mounting base 626. The driver cylinder 629 can be operably mounted to the arm assembly 628 to facilitate pivoting of the arm assembly 628 with respect to the mounting base 626. In one embodiment, the driver cylinder 629 can be a pneumatic drive. In other embodiments, any of a variety of drives can be used to facilitate powered pivoting of the arm assembly 628, such as, for example, a servo. The arm assembly 628 can include an arm 630, an extendible arm mount 632, and a head 634. The extendible arm mount 632 can be slidably coupled with the arm 630 and slidable along an axis A1 between a retracted position and an extended position. The head 634 can be mounted to the extendable arm mount 632 and can be configured to accommodate the tip dresser 624.

The mounting base 626 can facilitate mounting of the swing arm assembly 620 with fasteners (e.g., with bolts), to a floor, or at any of a variety of other suitable locations that allow the tip dresser 624 to interact properly with the spot welding machine (not shown). For example, when the spot welding machine is operating, the swing arm 622 can be in a stand-by position, such that the tip dresser 624 remains out of the operational zone of the spot welding machine. Once the welding tips are ready for dressing, the spot welding machine can cease spot welding, and the swing arm 622 can pivot the tip dresser 624 into position (via operation of the driver cylinder 629 and/or sliding of the extendible arm mount 632). The spot welding machine can then bring the welding tips into contact with a cleaning mechanism (not shown) on the tip dresser 624 to facilitate dressing of the welding tips. In one embodiment, the swing arm 622 can move the tip dresser 624 into place without requiring substantial movement of the spot welder. In another embodiment, the swing arm 622 and the spot welding machine can move together such that they meet at a predetermined location.

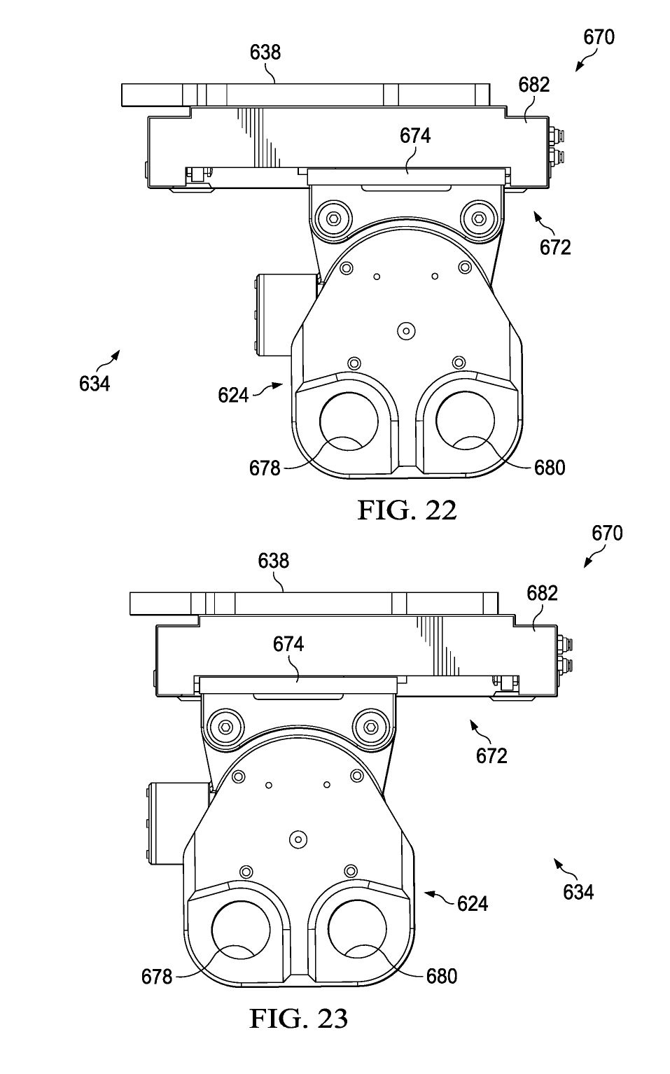

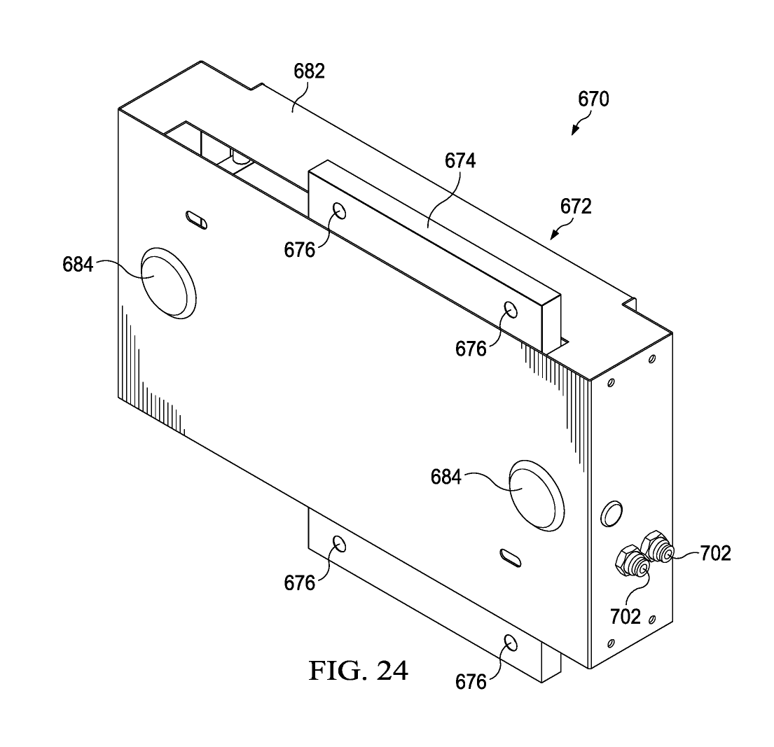

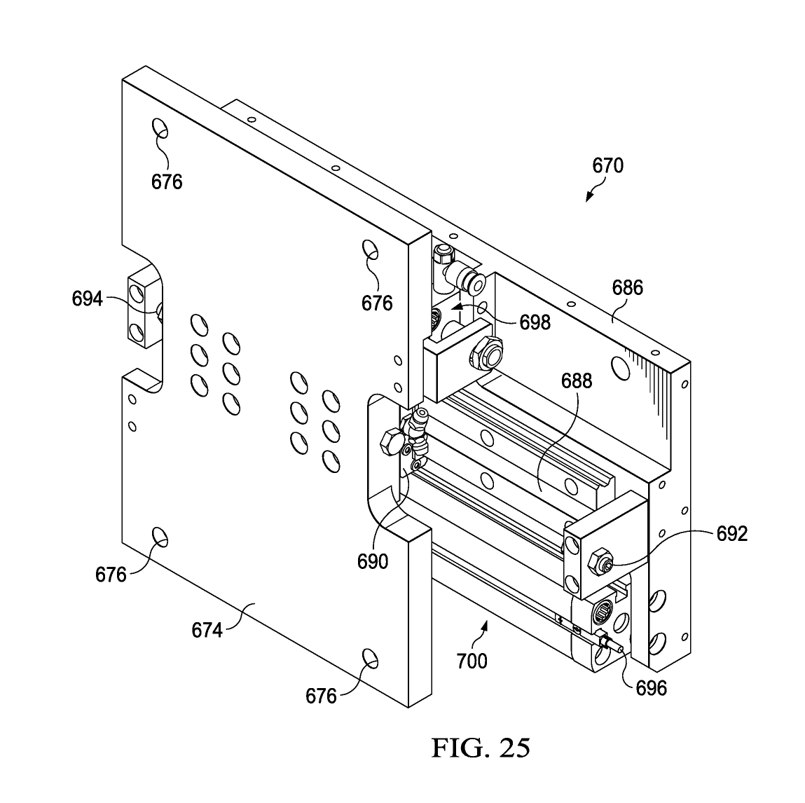

The swing arm assembly 620 can include a mount plate 638 that can be coupled with the head 634. Referring now to FIGS. 22 and 23, the mount plate 638 can include a plurality of attachment features that can facilitate the attachment of a shifter 670. The shifter 670 can include a body 672 and a slide plate 674. The tip dresser 624 can be releasably coupled to the slide plate 674 with fasteners (not shown) that can interact with holes 676 (FIGS. 24 and 25) defined by the slide plate 674. It is to be appreciated that the tip dresser 624 can be coupled with the slide plate 674 through any of a variety of suitable methods, such as through welding, for example.

The slide plate 674 can be slidable with respect to the body 672 along an axis A2 between a first position (FIGS. 20-22) and a second position (FIG. 23). In one embodiment, the axis A2 can be substantially parallel with the axis Al. When in the first position, the slide plate 674 can be laterally translated to a position proximate a distal end of the shifter 670. When in the second position, the slide plate 674 can be laterally translated to a position proximate a proximal end of the shifter 670. Although the slide plate 674 is shown to travel along a single axis (e.g., A2) it will be appreciated that it the slide plate 674 can alternatively be configured to move along multiple axes.

The slide plate 674 can be moved between the first and second positions to facilitate lateral movement of the tip dresser 624 relative to a weld tip. As illustrated in FIGS. 20-23, the tip dresser 624 can be a dual tip dresser that has a first cutting area 678 adjacent to a second cutting area 680. The first cutting area 678 can have dull cutting blades and the second cutting area 680 can have sharp cutting blades. Movement of the slide plate 674 between the first position and the second position can facilitate interaction of either the first cutting area 678 or the second cutting area 680 with a weld tip when the tip dresser 624 is moved into position (e.g., by the swing arm 622) to dress the weld tip. For example, the swing arm assembly 620 can swing the tip dresser 624 into interaction with a weld tip with the tip dresser 624 in the first position, such that the first cutting area 678 interacts with the weld tip. Once the weld tip has been treated by the first cutting area 678, the swing arm 622 can move the tip dresser 624 enough to remove the weld tip from the first cutting area 678. The slide plate 674 can then be moved to the second position, and the swing arm 622 can swing the tip dresser 624 into interaction with the weld tip such that the second cutting area 680 interacts with the weld tip.

In some embodiments, the weld tip might only need to interact with one of the first and second cutting areas 678, 680. Selection from between the first and second cutting areas 678, 680 can depend on a variety of factors, such as, for example, the cutting requirement for the tips, the amount of buildup on the tip, the tip material used (e.g., aluminum or copper), and/or any interference issues between the weld tips and the tip dresser 624 during the motion path. It will be appreciated that any suitable position of the slide plate 674 among the first and second positions is contemplated, where such movement may help avoid interference with weld tips or allow for precise positioning of the first and second cutting areas 678, 680.

Referring to FIG. 24, the body 672 can include a shell 682 that can be selectively removable to reveal various internal components. A plurality of plugs 684 can be selectively inserted into the shell 682. Referring to FIG. 25, one embodiment of the shifter 670 is shown with the shell 682 removed. The shifter 670 can include a base plate 686 upon which a linear guide rail 688 can be mounted. A linear guide carriage 690 can be coupled with the slide plate 674 and can be received in the linear guide rail 688. The linear guide carriage 690 can interact with the linear guide rail 688 to facilitate sliding of the slide plate 674 between the first and second positions. Adjustable position stoppers 692, 694 can be provided at each end of the linear guide rail 688 to prevent the linear guide carriage 690 from travelling beyond the linear guide rail 688. The adjustable position stoppers 692, 694 define the travel distance for the linear guide carriage 690 and thus the slide plate 674. In one embodiment, the adjustable position stoppers 692, 694 can be selectively adjusted (e.g., manually, remotely, and/or automatically) to define different travel distances (e.g., for different applications).

A position sensor 696 can detect the position of the linear guide carriage 690 (and thus the slide plate 674) along the linear guide rail 688 and can communicate the position to a controller (not shown) to facilitate automated positioning of the slide plate 674 and associated tip dresser (e.g., 624). The controller can be a programmable logic controller (PLC) or any of a variety of other suitable additional or alternative controller. The controller can be associated with pre-programmed specifications, programs, and/or modes to facilitate changes between operational needs.

Still referring to FIG. 25, the shifter 670 can include a first pneumatic cylinder 698 and a second pneumatic cylinder 700 that is operably coupled with the slide plate 674 and configured to slide the slide plate 674 towards the first position and the second position, respectively. The first and second pneumatic cylinders 698, 700 can be fluidly coupled with one of a pair of pneumatic fittings 702 and powered by a fluid source (not shown), such as a source of compressed air, for example, that is coupled with the pneumatic fittings 702. Although a compact two-cylinder design is illustrated, other pneumatic cylinder designs and suitable number of cylinders are contemplated, such as a single cylinder design. It will be appreciated that the slide plate 674 can be actuated with any of a variety of suitable alternative power sources, such as electrically, for example. It is also to be appreciated that the shifter 670 can be any suitable shape or configuration, although a relatively flat box-shaped configuration may be beneficial to avoid interference.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto.

What is claimed is:

1. A swing arm for one or more of a tip dresser and a tip exchanger for a spot welding machine, the swing arm comprising:
a base;
an arm pivotally coupled with the base; and
a shifter coupled with the arm, the shifter comprising:
a body; and
a slide plate configured to accommodate one or more of a tip dresser and a tip exchanger for a spot welding machine, wherein the slide plate is movable with respect to the body along a first axis between a first position and a second position.

2. The swing arm of claim 1 wherein the shifter is slidably coupled with the arm such that the shifter is extendible along a second axis that is substantially perpendicular to the first axis.

3. The swing arm of claim 1 wherein the shifter further comprises:
a first pneumatic cylinder operably coupled with the slide plate and configured to slide the slide plate towards the first position; and
a second pneumatic cylinder operably coupled with the slide plate and configured to slide the slide plate towards the second position.

4. The swing arm of claim 1 wherein the slide plate is slidable with respect to the body only along the first axis.

5. The swing arm of claim 4 further comprising a pair of position stoppers that define a travel distance of the slide plate and are selectively adjustable to change the travel distance.

6. The swing arm of claim 1 further comprising one of a driver cylinder and a servo operably mounted to the arm that facilitates in powered pivoting of the arm with respect to the base.

7. The swing arm of claim 1 further comprising a position sensor configured to detect the position of the slide plate and communicate the position to a controller to facilitate automated positioning of the slide plate.

8. A welding system comprising:
a spot welding machine;
a swing arm comprising:
a base;
an arm pivotally coupled with the base; and
a shifter coupled with the arm, the shifter comprising:
a body; and
a slide plate movable with respect to the body along a first axis between a first position and a second position; and
one or more of a tip dresser and a tip exchanger coupled with the slide plate.

9. The welding system of claim 8 wherein the shifter is slidably coupled with the arm such that the shifter is extendible along a second axis that is substantially perpendicular to the first axis.

10. The welding system of claim 8 wherein the shifter further comprises:
a first pneumatic cylinder operably coupled with the slide plate and configured to slide the slide plate towards the first position; and
a second pneumatic cylinder operably coupled with the slide plate and configured to slide the slide plate towards the second position.

11. The welding system of claim 8 wherein the slide plate is slidable with respect to the body only along the first axis.

12. The welding system of claim 11 further comprising a pair of position stoppers that define a travel distance of the slide plate and are selectively adjustable to change the travel distance.

13. The welding system of claim 8 further comprising one of a driver cylinder and a servo operably mounted to the arm that facilitates in powered pivoting of the arm with respect to the base.

14. The welding system of claim 8 further comprising a position sensor configured to detect the position of the slide plate and communicate the position to a controller to facilitate automated positioning of the slide plate.

15. The welding system of claim 9 wherein the one or more of a tip dresser and a tip exchanger comprises a tip dresser that comprises a first cutting area and a second cutting area.

16. The welding system of claim 15 wherein each of the first cutting area and the second cutting area comprise cutting blades and wherein the cutting blades of the first cutting area are duller than the cutting blades of the second cutting area.

17. A shifter for a swing arm for one or more of a tip dresser and a tip exchanger for a spot welding machine, the shifter comprising:
a body; and
a slide plate configured to accommodate one or more of a tip dresser and a tip exchanger for a spot welding machine, wherein the slide plate is movable with respect to the body along a first axis between a first position and a second position.

18. The shifter of claim 17 wherein the shifter further comprises:
a first pneumatic cylinder operably coupled with the slide plate and configured to slide the slide plate towards the first position; and
a second pneumatic cylinder operably coupled with the slide plate and configured to slide the slide plate towards the second position.

19. The shifter of claim 17 wherein the slide plate is slidable with respect to the body only along the first axis.

20. The shifter of claim 17 further comprising a pair of position stoppers that define a travel distance of the slide plate and are selectively adjustable to change the travel distance.
